(19) United States
(12) Patent Application Publication
(10) Pub. No.: US 2018/0347782 A1
(43) Pub. Date: Dec. 6, 2018

(54) Lamp Cover and TV Cover

(71) Applicant: Leola Brantley, Rochester, NY (US)

(72) Inventor: Leola Brantley, Rochester, NY (US)

(21) Appl. No.: 15/929,023

(22) Filed: Jul. 12, 2018

Related U.S. Application Data
(63) Continuation-in-part of application No. 15/330,265, filed on Aug. 25, 2016, now abandoned.

(51) Int. Cl. F21V 1/22; F21V 1/04; F21V 1/20; H04N 5/64

(52) U.S. Cl. CPC F21V 1/22; H04N 5/64; F21V 1/20; F21V 1/04

(57) ABSTRACT

Disclosed herein are lamp covers used to change the appearance of a lamp. The lamp covers may be slid over an existing lamp without contacting a lamp or light. Also disclosed herein are TV covers used to change the appearance of a TV. The TV covers are easily placed on the front of a TV (such as on the frame of a TV) and removed therefrom as desired by a user.

### CROSS REFERENCE TO RELATED APPLICATIONS

This document is a continuation in part application of U.S. Nonprovisional Utility application Ser. No. 15/330,265, entitled “Switch UPS floor lamp cover and TV frame cover,” naming as first inventor Leola Brantley, which was filed on Aug. 25, 2016, now pending, the disclosure of which is hereby incorporated entirely herein by reference.

### BACKGROUND

### 1. Technical Field

Aspects of this document relate generally to covers for lamps and televisions (TVs).

### 2. Background Art

Lampshades exist in the art and are used to diffuse light and provide a decorative covering over a light bulb. Some TV coverings exist in the art and are used to provide a decorative cover for a TV.

### SUMMARY

Embodiments of lamp covers may include: a plurality of rigid frame members, and; a translucent member attached to the rigid frame members; wherein the rigid frame members and the translucent member define a top opening, a bottom opening, and a cavity extending from the bottom opening to a top of the lamp cover; wherein the lamp cover is sized and shaped to circumscribe a lamp having a light bulb, and; wherein the lamp cover includes no element coupled thereto configured to attach to the lamp and wherein the lamp cover includes no element coupled thereto configured to attach to the light bulb.

Embodiments of lamp covers may include one or more or all of the following:

The rigid frame members may include a top frame member, a bottom frame member, and a plurality of side frame members.

The translucent member may be the innermost portion of the lamp cover.

The lamp cover may include no legs extending downward from the rigid frame members.

A height of the lamp cover may be greater than a width of the lamp cover.

The lamp cover may include a top opening, and the cavity may be a through-hole extending from the top opening to the bottom opening.

The top opening may be sized equivalently to the bottom opening.

The lamp cover may have a narrowing section between the top of the lamp cover and the bottom opening.

The lamp cover may include no element extending into the cavity.

Methods of using a lamp cover may include: providing a lamp cover having a plurality of rigid frame members and a translucent member attached to the rigid frame members, the rigid frame members and the translucent member defining a bottom opening and a cavity extending from the bottom opening to a top of the lamp cover; inserting a lamp through the bottom opening and into the cavity; circumscribing the lamp with the lamp cover by placing the lamp cover on a surface upon which the lamp is resting, and; not coupling the lamp cover to the lamp.

Embodiments of methods of using a lamp cover may include one or more or all of the following:

The lamp cover may include no element coupled thereto configured to attach to the lamp and the lamp cover may include no element coupled thereto configured to attach to a light bulb of the lamp.

The translucent member may be the innermost portion of the lamp cover.

The lamp may further include a lampshade, and circumscribing the lamp with the lamp cover may further include circumscribing the lampshade with the lamp cover.

The lamp cover may include a top opening, and the cavity may be a through-hole extending from the top opening to the bottom opening.

The lamp cover may include no element extending into the cavity.

Embodiments of television (TV) covers may include: a rigid rectangle having a rectangular opening defined by a top member, a bottom member, a first side member, and a second side member of the rigid rectangle, and; a plurality of curved clips extending perpendicularly away from the rigid rectangle, each curved clip being curved towards a center of the rigid rectangle.

Embodiments of TV covers may include one or more or all of the following:

The plurality of curved clips may consist of a first curved clip extending from a back of the top member and a second curved clip extending from a back of the bottom member.

The plurality of curved clips may consist of a first curved clip extending from a back of the top member, a second curved clip extending from a back of the bottom member, a third curved clip extending from a back of the first side member, and a fourth curved clip extending from a back of the second side member.

A first gap may be formed between the first curved clip and the second curved clip, a second gap may be formed between the second curved clip and the third curved clip, a third gap may be formed between the third curved clip and the fourth curved clip, and a fourth gap may be formed between the fourth curved clip and the first curved clip.

The rigid rectangle and the plurality of curved clips may be formed of a rigid polymer.

The rigid rectangle and the plurality of curved clips may be formed of a single piece of polymer.

General details of the above-described embodiments, and other embodiments, are given below in the DESCRIPTION, the DRAWINGS, and the CLAIMS.

### BRIEF DESCRIPTION OF THE DRAWINGS

Embodiments will be discussed hereafter using reference to the included drawings, briefly described below, wherein like designations refer to like elements:

FIG. 1A is a front perspective view of a lamp cover;

FIG. 1B is a front perspective view of another lamp cover;

FIG. 2 is a top view of the lamp cover of FIG. 1A;

FIG. 3 is a front view of a TV cover;

FIG. 4 is a top view of the TV cover of FIG. 3;

FIG. 5 is a side view of the TV cover of FIG. 3;

FIG. 6 is a front see-through view of the lamp cover of FIG. 1A placed around a floor lamp;

FIG. 7 is a top view of the lamp cover and floor lamp of FIG. 6;

FIG. 8 is a front see-through view of the lamp cover of FIG. 1A placed around a table lamp, the table lamp having a lampshade installed;

FIG. 9 is a front see-through view of the lamp cover and table lamp of FIG. 8 with the lampshade uninstalled, exposing the light bulb;

FIG. 10 is a front perspective view of another lamp cover having an enclosed top portion;

FIG. 11 is a top view of the lamp cover of FIG. 10;

FIG. 12 is a front view of another implementation of a TV cover;

FIG. 13 is a top view of the TV cover of FIG. 12;

FIG. 14 is a side view of the TV cover of FIG. 12;

FIG. 15 is a front view of another implementation of a TV cover;

FIG. 16 is a top view of the TV cover of FIG. 15, and;

FIG. 17 is a side view of the TV cover of FIG. 15.

### DESCRIPTION

Implementations/embodiments disclosed herein (including those not expressly discussed in detail) are not limited to the particular components or procedures described herein. Additional or alternative components, assembly procedures, and/or methods of use consistent with the intended lamp covers and TV covers may be utilized in any implementation. This may include any materials, components, sub-components, methods, sub-methods, steps, and so forth.

Lamp covers disclosed herein provide inexpensive, quick and efficient ways to remodel existing lamps with a new look. TV covers disclosed herein provide inexpensive, quick and efficient ways to remodel existing TVs with a new look.

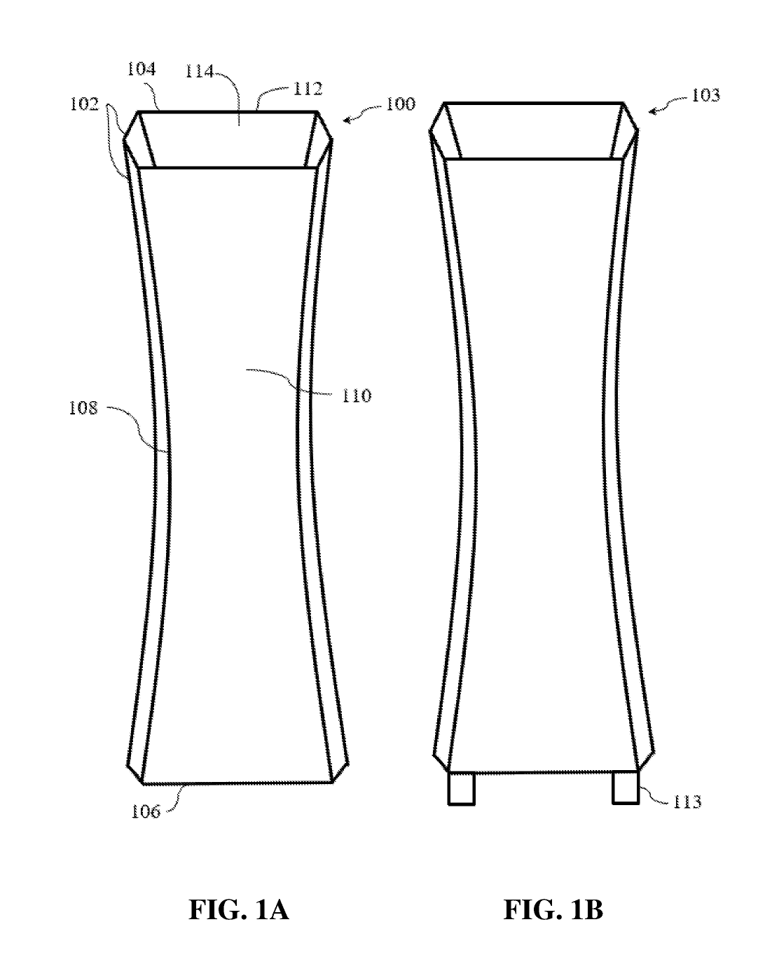

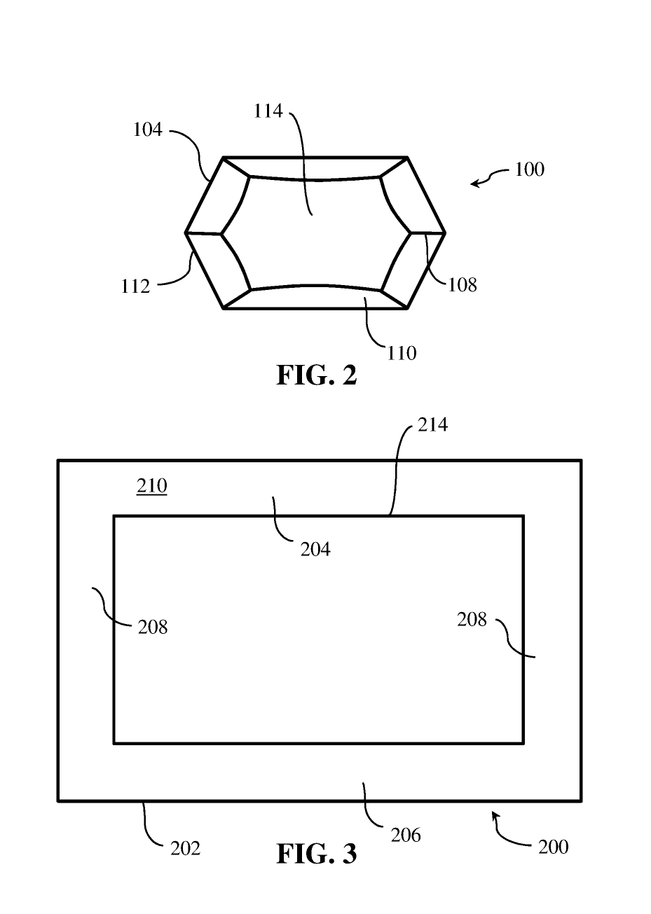

Referring to FIGS. 1A and 2, in implementations a lamp cover 100 is formed of a translucent member 100 coupled with rigid frame members 102. The rigid frame members of the implementation of FIGS. 1A and 2 includes a top frame member 104, a bottom frame member 106 and a plurality of side frame members 108. In this case each side frame member is attached to the top frame member and to the bottom frame member. The rigid frame members may be formed of any rigid material such as rigid wood or plastic poles, metal wires, or some other rigid material.

The translucent member may be formed of glass, plastic/polymer, cloth/fabric, or some other material that is translucent. The translucent member may in some implementations be transparent. In the implementation shown in the figures the translucent member is not transparent, but is translucent, and is formed of a flexible fabric. In implementations in which the translucent member is formed of glass it may be rigid and transparent, though the glass may be colored to an extent that it is not transparent but is translucent. The translucent member may be any color, and it may or may not have a frosted appearance. In implementations in which the translucent member is flexible it may be stretched tight by the rigid frame members. The rigid frame members could be placed internally within pockets or slots or the like of the translucent member, or the translucent member could be wrapped around the rigid frame members or located between the rigid frame members and attached thereto such as with ties or the like.

An opening 112 is formed at the top of the lamp cover and provides access to a through-hole 114 which extends all the way through the lamp cover from the top opening to a bottom opening. The through-hole is defined by one or more inner sidewalls of the translucent member, as can be seen in FIGS. 1A and 2 (in the implementation shown the through-hole is defined by multiple inner sidewalls, in the case in which the cross-section of the lamp cover is circular or oval or elliptical or having another smoothly curving shape there may be only a single inner sidewall). As can be seen in the figures, the translucent member itself is the innermost member or portion of the lamp cover (in other words, when looking downward through the through-hole as from the perspective of FIG. 2, the innermost element is the translucent member).

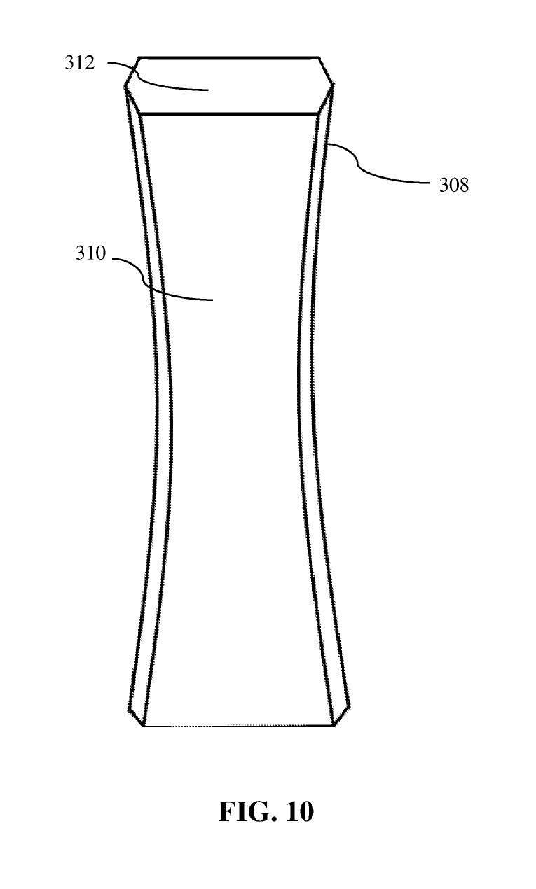

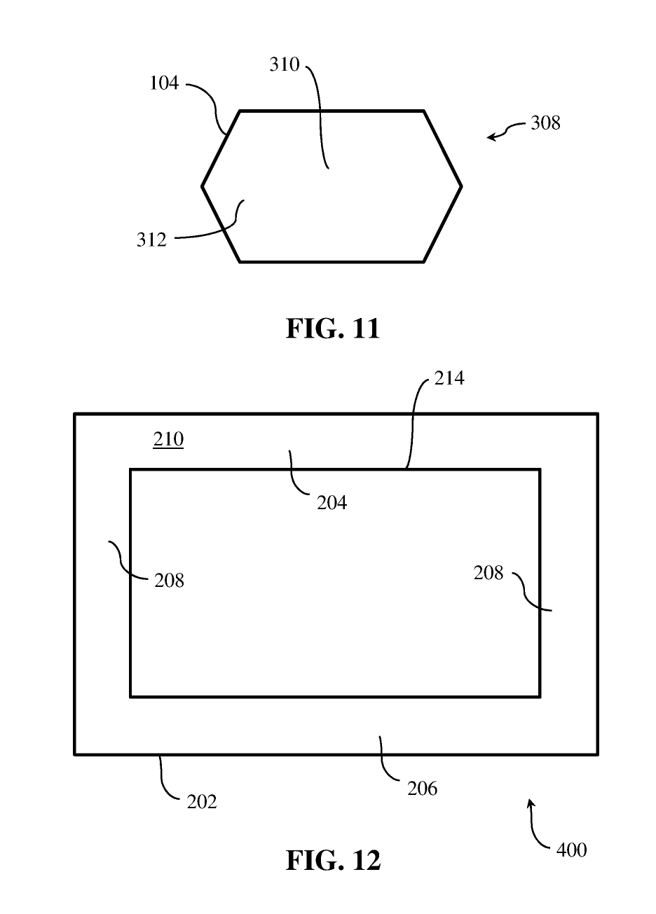

In some implementations a lamp cover 308, as seen in FIGS. 10-11, is identical to other lamp cover 100 except that it includes a translucent member 310 which has a top portion 312 to cover the top of the lamp cover, so that there is not a top opening. There would still be a bottom opening however, and a cavity (instead of a through-hole) would extend all the way from the bottom opening to the top portion 312, for receiving a lamp or light. In these implementations the lamp cover not only sits around the lamp/light bulb but also covers the lamp/light bulb.

The lamp cover does not include any element designed specifically to couple directly to a lamp or light. Rather, the lamp cover is sized and shaped so that it simply slides over, and may be positioned around, an existing light or lamp. Some traditional table lampshades, for example, include a lampshade fitting and lock configured to lock the lampshade to a harp of the lamp so that the lame shade, when secured in place, cannot move relative to the light bulb. The lamp covers disclosed herein have no such elements, in fact they include no elements configured to prevent the lamp cover from moving relative to the light bulb. In some cases the lamp cover may be placed around an existing lamp, which already has its own lampshade, to provide a new look for the lamp (in other words, in that case the lamp may include a lampshade, and the lamp cover may be placed around the lampshade). The lamp cover is not a traditional lampshade in that it is not configured to couple to a light or lamp, but is instead configured to be placed around a lamp or light without touching the lamp, the light, the body of the lamp, or any other portion of the lamp/light. As can be seen by FIG. 2, there is no element of the lamp cover that is designed to couple or attach a light or lamp to the lamp cover. This provides for an immediate remodeling of an existing lamp—the user simply places the cover around the lamp or light, without in any way attaching the light or lamp to the lamp cover, and the remodeling is complete. The user may of course immediately remove the lamp cover when desired to restore the lamp or light to its previous appearance.

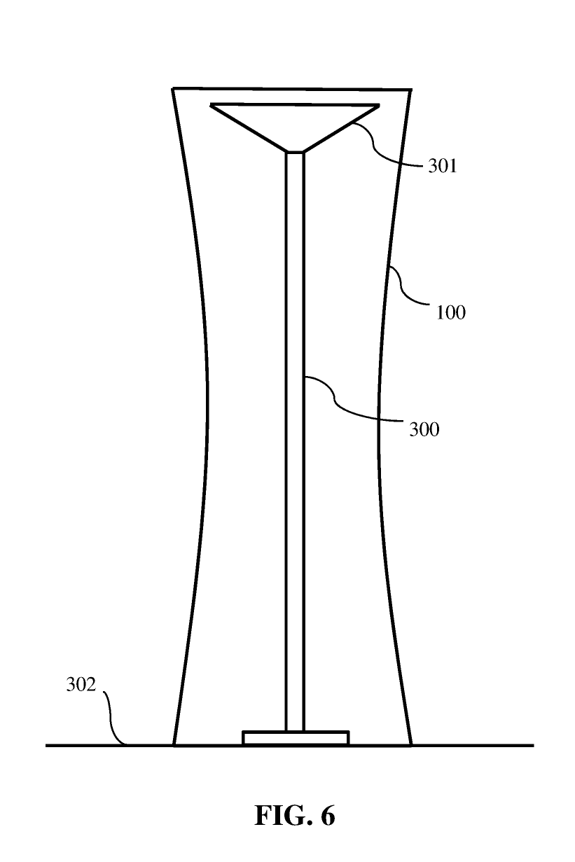

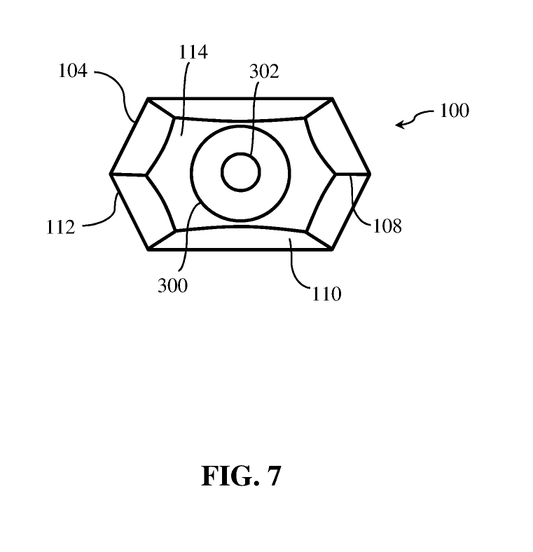

For example, referring to FIG. 6, lamp cover 100 may be placed around a floor lamp 300 so that the floor lamp 300 and lamp cover 100 sit on the same surface 302, but are otherwise not coupled to one another, the lamp cover 100 simply set around the floor lamp. As defined herein, “not coupling the lamp cover to the lamp” is defined as not coupling the lamp cover and lamp together apart from setting them on the same surface and the lamp cover in some implementations (for example the legless versions) contacting an electrical cord powering the lamp. This allows the lamp cover to be used to redecorate, or change the appearance of the floor lamp, in one easy motion of placing the lamp cover in place. Referring to FIG. 7, it may be seen that the innermost sidewalls of the lamp cover do not touch the floor lamp 300 (the light bulb 302 of the floor lamp may also be seen in FIG. 7).

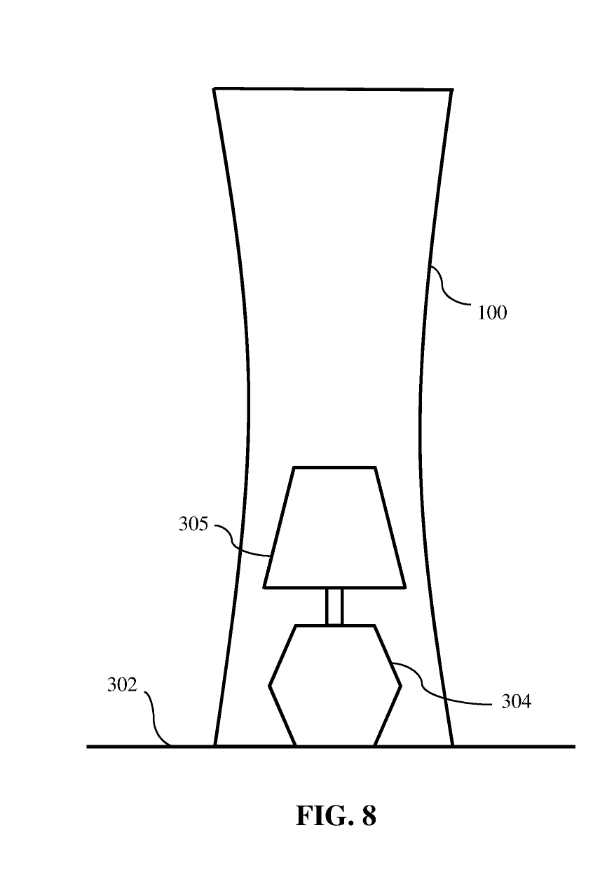

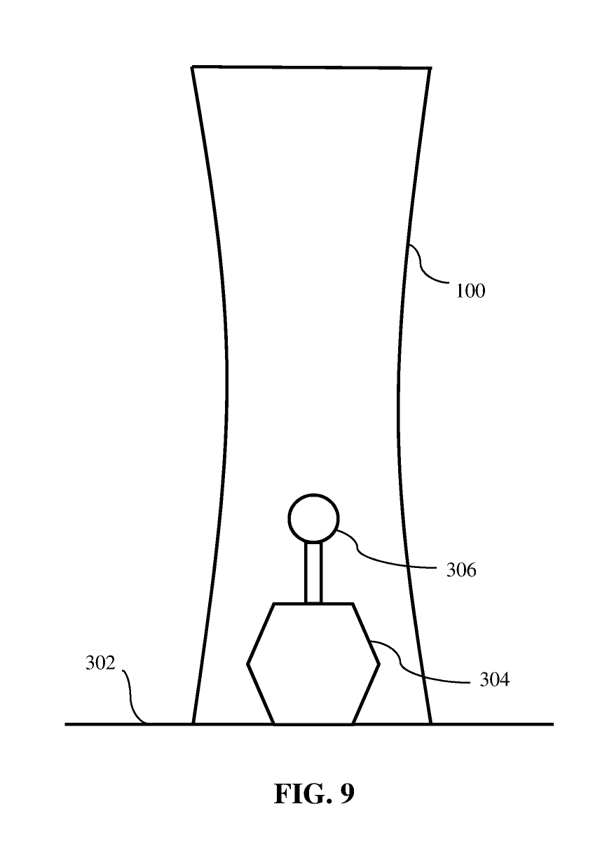

Referring to FIG. 8, lamp cover 100 may be placed around a table lamp 304 so that the table lamp 304 and lamp cover 100 sit on the same surface 302 but are otherwise not coupled to one another, the lamp cover 100 simply set around the table lamp. This allows the lamp cover to be used to redecorate, or change the appearance of the table lamp in one easy motion of placing the lamp cover in place. In FIG. 8 the table lamp is seen to have the lampshade 305 in place—thus the lamp cover may be used while the lampshade of the table lamp is in place. However, in FIG. 9 it may be seen that the lampshade has been removed, exposing the light bulb 306. Thus the lampshade may be removed so that more light passes through the lamp cover to light a room. The light director 301 of the floor lamp could be removed for a similar effect when the lamp cover is used with a floor lamp. The top view of the lamp cover, when used with a table lamp, may be similar to that shown in FIG. 7 for the floor lamp, so that the innermost sidewalls of the lamp cover would be seen to not be touching any components of the table lamp.

Lamp covers could have a variety of shapes. The lamp cover of FIGS. 1A and 2 seen from the top has a roughly hexagonal elongated shape with a narrowing midsection. Other lamp covers could exclude the narrowing and could have cross sections which are rectangular, square, circular, oval, elliptical, triangular, polygonal (including any number of sides), and any other regular or irregular shape.

The lamp cover shown in the drawings has a tall configuration with a height that is noticeably larger than its width. Other lamp covers could be shorter or wider, but the configuration shown in the drawing may allow the lamp cover to be placed around (and over in the case of lamp covers having closed tops) short lamps and tall standing lamps as desired and still circumscribe the lamp or light, without any portion of the lamp or light extending above the top opening 112 of the lamp/light.

The lamp cover shown in the drawings does not have legs that extend below the bottom frame member, but in implementations such legs may be present, as with the lamp cover 103 of FIG. 1B which has legs 113. The lamp cover 103 is identical to lamp cover 100 except that it has legs. In such implementations the bottom frame member will rest above the ground or surface upon which the legs reside. The legs may extend downwardly from the bottom frame member (they may be attached to the bottom frame member), though they may alternatively be attached to the side frame members (or both side and bottom frame members). The lamp cover may be very lightweight and easy for a user to pick up and place over an existing light or lamp. Even so, as described above the lamp cover may be formed of plastics/polymers, glasses, canvases, fabrics, and other lightweight materials, and the like, and may be very durable.

The lamp cover could include any of a variety of images, color schemes, themes or designs to function as a festive thematic decoration such as for Christmas, Halloween, Thanksgiving, birthday, anniversary, a sports team or sports event, and so forth, to provide for quick and easy decoration (and takedown) of event decorations. In other implementations the lamp cover may not have a theme but may just have one or more colors that will allow the user to change home dećor as desired.

The lamp cover may be slipped or positioned over/around any new or old lamp or light to refurbish it or change its look, at least temporarily until the user desires to remove the lamp cover to another location. The lamp cover allows a user to inexpensively, quickly and conveniently change the aesthetic appearance of a lamp as desired. The lamp on which the lamp cover is used may be a tall standing lamp (floor lamp) or a shorter table or desk lamp, or another type of lamp.

In some implementations the lamp cover does not have separate frame elements but is simply constructed as a single piece—for example a single frosted glass member formed into a desired shape (by non-limiting example, the shape shown in FIGS. 1A and 2) or a single rigid polymer member formed into a desired shape (by non-limiting example, the shape shown in FIGS. 1A and 2) such as by 3-D printing or the like, and capable of standing upright on its own accord without separate rigid frame members such as the top frame member, bottom frame member, and side frame members. In implementations the lamp cover may be formed of or may include other materials, such as woods, ceramics, composites, and the like, each of which may be colored or stained as desired to provide aesthetic appeal. The shape of the lamp cover may in implementations be made to curve and flow smoothly, as seen in FIGS. 1A and 2. Heating steps, melting, heat bonding, gluing, screwing, and other manufacturing/joining methods may be used in the fabrication of the lamp cover, which may in implementations be fabricated by hand using hand tools.

As indicated above, the bottom of the lamp cover may be level and designed to allow the lamp cover to stand upright without the use of separate legs or separate legs may be used. The lamp cover may be formed in various styles, shapes and sizes so that different styles and sizes of lamps may be covered, though in some implementations the lamp cover may be tall and large enough so that many different lamp styles may be covered by the lamp cover. In some implementations the lamp cover may have a size of, or of about, 5½ feet tall by 1½ feet wide, with the hollow through-hole about 1½ feet wide at its widest to receive the lamp/light. In some implementations the top opening and bottom opening are the same size and the same shape—though in other implementations they could have different sizes or different shapes. As can be seen by the Figures, there is no element of the lamp cover that extends into the cavity between the top of the lamp cover and the bottom opening.

As can be seen in the figures, the lamp cover has no element extending into the through-hole, and no element configured to attach to a lamp or light. This allows the lamp cover to be placed directly over a lamp without attaching to or coupling to the lamp. This allows the lamp cover to be quickly and easily placed around a lamp and removed from around the lamp as desired.

In some implementations the lamp cover could be used as a standalone decoration, i.e., not placed around a lamp but simply standing alone in a room.

Referring now to FIGS. 3-5, an implementation of a TV cover 200 is shown. The TV cover, like the lamp cover, provides a quick and easy way for remodeling or decorating a TV. The TV cover may be coupled with an existing television to provide a new look for the television. The TV cover forms the shape of a rigid rectangle 202 which includes a top member 204, a bottom member 206, and two side members 208. Although the rectangle is shown having sharp outer and inner corners, in other implementations the outer and/or inner corners could be rounded. A rectangular opening 214 is concentrically formed within the rigid rectangle and extends from the front 210 to the back 212 of the TV cover. The TV cover is sized and shaped to frame a television and the rectangular opening is sized to fit very closely with the screen size of the television so that the user will not see (or not see much of) any portion of the TV apart from the screen itself (but also so that no portion of, or very little of, the actual screen is covered by the TV cover). The TV cover may be used to cover an existing TV frame which was part of the TV as originally manufactured/purchased.

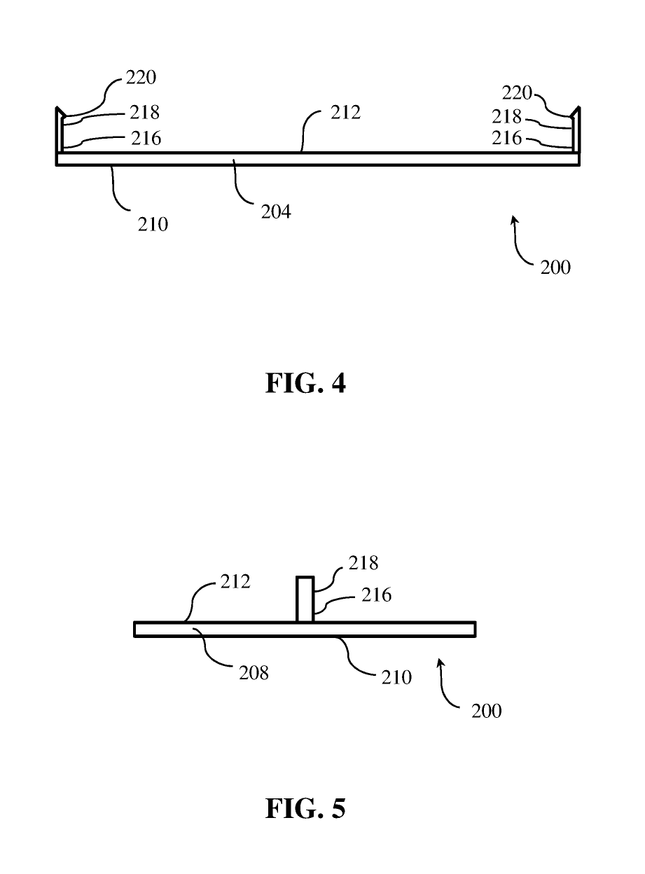

FIGS. 4-5 show the mechanism by which the TV cover couples with or attaches to a TV using a friction fit between the TV and a pair of side friction members 216. Each side friction member includes a perpendicular extension 218 that extends perpendicularly from the back of the TV cover and, on an inner portion thereof (a portion facing inwards towards a center of the TV cover or in other words towards the rectangular opening) a protrusion is formed. The protrusions are seen to extend towards one another. When the TV cover is slid over the front of a TV of the appropriate size, the protrusions of the side friction members engage with the sides of the TV in a friction fit. The size of the side friction members (for example the length to which they extend from the back of the TV cover) may be different for different models, such as some being designed for flat-screen TVs and others for thicker-screened TVs. FIG. 5 shows that, in implementations, each side friction member is a relatively narrow member that extends from a side member and is positioned centrally, or roughly centrally, between the top member and bottom member.

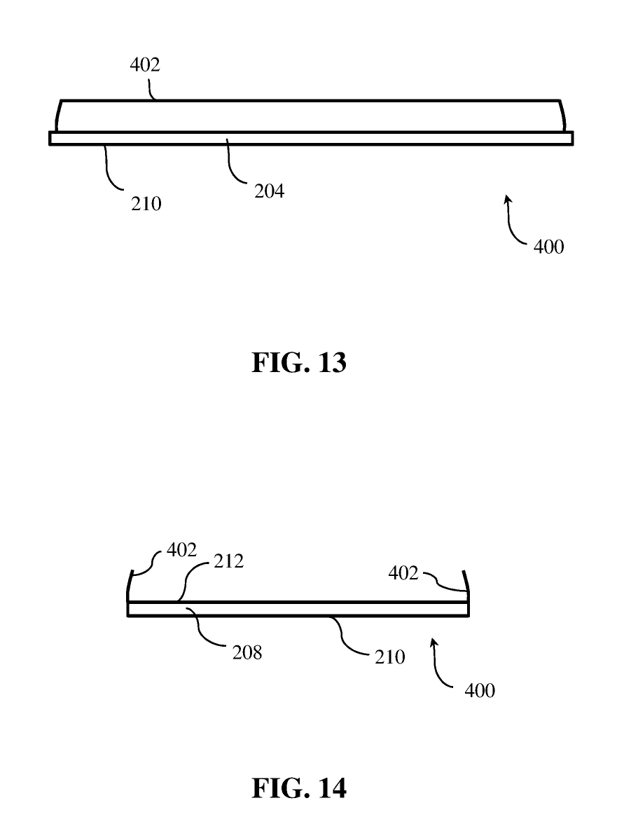

FIGS. 12-14 show another implementation of a TV cover 400. TV cover 400 has many of the same features of TV cover 200, as shown in the drawings, but instead of the side friction members TV cover 400 includes a first curved clip 402 extending from the back of the top member 204 and a second curved clip 402 extending from the back of the bottom member 206. FIG. 13 is a top view of TV cover 400 showing that the top curved clip extends along most of the top of the TV cover and the bottom view would be an identical image revealing that the bottom curved clip extends along most of the bottom of the TV cover. FIG. 14 is a side view of the TV cover 400 showing that the curved clips in implementations are relatively thin and, accordingly, easily deform elastically so that the TV cover may be snapped into place onto a TV frame. Nevertheless, in implementations the curved clips are formed of a rigid material, such as a rigid polymer.

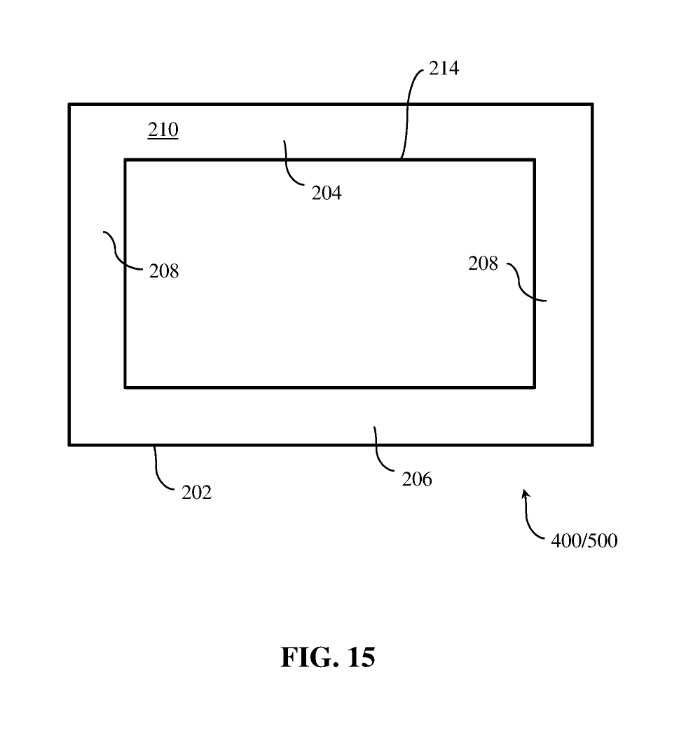

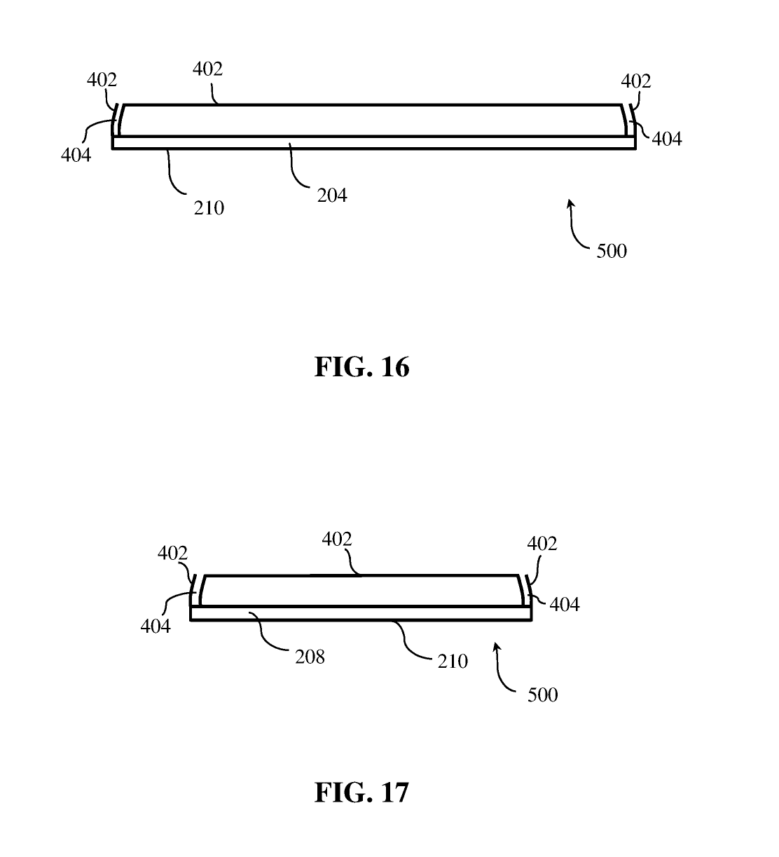

FIGS. 15-17 show another implementation of a TV cover 500. TV cover 500 has many of the same features of TV cover 200 as shown in the drawings, but instead of the side friction members TV cover 500 includes a first curved clip 402 extending from the back of the top member 204, a second curved clip 402 extending from the back of the bottom member 206, and a third and a fourth curved clip 402 each extending from the back of a side member 208. FIG. 16 is a top view of TV cover 500 showing that the top curved clip extends along most of the top of the TV cover and the bottom view would be an identical image revealing that the bottom curved clip extends along most of the bottom of the TV cover. It is seen in FIG. 16 that there is a gap 404 between the top curved member and each side curved member, similarly there is a gap 404 between the bottom curved member and each side curved member, each gap 404 being located at a corner of the rigid rectangle. FIG. 17 is a side view of the TV cover 500 showing that each side curved member extends along most of a side of the TV cover 500. The curved clips of TV cover 500 are seen to be, in implementations, relatively thin and, accordingly, easily deform elastically so that the TV cover may be snapped into place onto a TV frame.

It is seen that each of the curved clips of TV covers 400/500 curves inwards towards a center of the rigid rectangle. The relative sizes of the curved clips and the rigid rectangle are not necessarily drawn to scale, in some cases the curved clips may be shorter than shown in the drawings, or in some cases taller. The curved clips and the rigid rectangle may be fabricated together—for example molded together. In other implementations the curved clips could be formed/fabricated separately and joined to the rigid rectangle using adhesives, screws, and/or other joining elements. The curved clips allow the TV covers 400/500 to easily be snapped into place on a TV frame and, as desired, easily removed from the TV frame.

The TV frame cover may be formed of a flexible polymer or rubber in some implementations, and in other implementations may be formed of a rigid polymer or semi-rigid polymer. In some implementations the rigid rectangle may be rigid but the side friction members may be somewhat flexible to allow them to bend while forming a friction fit with a TV. The side friction members provide somewhat of a snap-on attachment mechanism by which the TV cover is snapped onto a TV. The user may remove the TV cover from a TV by simply pulling the cover away from the TV with enough manual force to overcome the friction fit or, alternatively, pulling outwards on the side friction members so that the protrusions and/or the perpendicular extensions are not contacting the TV, and then pulling the TV cover away from the TV.

TV covers may come in a variety of sizes and shapes, including different widths and heights for coupling to different TVs. The TV covers may come in a variety of colors (such as a single-color TV cover or a multiple-color TV cover) and may include thematic images such as is described above for the lamp covers (for example a Christmas-themed cover, a Halloween-themed cover, etc.). In implementations the TV covers may be clear or have a frosted translucent appearance, in other implementations they may be fully opaque. The TV covers may be inexpensive and may provide a very quick and easy way for a user to decorate a TV, and remove the decoration from the TV, as desired. They thus provide a convenient, quick and economic way to change the aesthetics of a television.

In implementations, as in the implementations shown in the drawings, the TV covers will be constructed as a single piece. In other implementations the rigid rectangle and side friction members may be formed of separate pieces but of the same material and joined together. In still other implementations the rigid rectangle and side friction members may be formed of different materials. The TV covers may be formed of polymer, such as any plastic or rubber material, which may be flexible or rigid, or may be formed of wood, metal, composite, or ceramic materials. The TV covers may be very lightweight. The TV covers in some implementations may be able to be fabricated by hand using hand tools, and various elements of the TV covers may be joined and/or bent using heat tools, adhesives, screws, and so forth. In some implementations the side friction members may be formed separately from the rigid rectangle and joined thereto using adhesives or screws or the like. Any elements of the TV covers may be colored or stained using coloring/staining elements to achieve a desired appearance.

In places where the description above refers to specific embodiments of lamp covers and tv covers, one or more or many modifications may be made without departing from the spirit and scope thereof. Details of any specific embodiment/implementation described herein may, wherever possible, be applied to any other specific implementation/embodiment described herein.

What is claimed is:

1. A lamp cover, comprising:
a plurality of rigid frame members, and;
a translucent member attached to the rigid frame members;
wherein the rigid frame members and the translucent member define a bottom opening and a cavity extending from the bottom opening to a top of the lamp cover;
wherein the lamp cover is sized and shaped to circumscribe a lamp having a light bulb, and;
wherein the lamp cover comprises no element coupled thereto configured to attach to the lamp and wherein the lamp cover comprises no element coupled thereto configured to attach to the light bulb.

2. The lamp cover of claim 1, wherein the rigid frame members include a top frame member, a bottom frame member, and a plurality of side frame members.

3. The lamp cover of claim 1, wherein the translucent member comprises an innermost portion of the lamp cover.

4. The lamp cover of claim 1, wherein the lamp cover comprises no legs extending downward from the rigid frame members.

5. The lamp cover of claim 1, wherein a height of the lamp cover is greater than a width of the lamp cover.

6. The lamp cover of claim 1, wherein the lamp cover comprises a top opening, and wherein the cavity comprises a through-hole extending from the top opening to the bottom opening.

7. The lamp cover of claim 6, wherein the top opening is sized equivalently to the bottom opening.

8. The lamp cover of claim 1, wherein the lamp cover has a narrowing section between the top of the lamp cover and the bottom opening.

9. The lamp cover of claim 1, wherein the lamp cover comprises no element extending into the cavity.

10. A method of using a lamp cover, comprising:
providing a lamp cover comprising a plurality of rigid frame members and a translucent member attached to the rigid frame members, the rigid frame members and the translucent member defining a bottom opening and a cavity extending from the bottom opening to a top of the lamp cover;
inserting a lamp through the bottom opening and into the cavity;
circumscribing the lamp with the lamp cover by placing the lamp cover on a surface upon which the lamp is resting, and;
not coupling the lamp cover to the lamp.

11. The method of claim 10, wherein the lamp cover comprises no element coupled thereto configured to attach to the lamp and wherein the lamp cover comprises no element coupled thereto configured to attach to a light bulb of the lamp.

12. The method of claim 10, wherein the translucent member comprises an innermost portion of the lamp cover.

13. The method of claim 10, wherein the lamp further comprises a lampshade, and wherein circumscribing the lamp with the lamp cover further comprises circumscribing the lampshade with the lamp cover.

14. The method of claim 10, wherein the lamp cover comprises no element extending into the cavity.

15. A television (TV) cover, consisting of:
a rigid rectangle having a rectangular opening defined by a top member, a bottom member, a first side member, and a second side member of the rigid rectangle, and;
a plurality of curved clips extending perpendicularly away from the rigid rectangle, each curved clip being curved towards a center of the rigid rectangle.

16. The TV cover of claim 15, wherein the plurality of curved clips consist of a first curved clip extending from a back of the top member and a second curved clip extending from a back of the bottom member.

17. The TV cover of claim 15, wherein the plurality of curved clips consist of a first curved clip extending from a back of the top member, a second curved clip extending from a back of the bottom member, a third curved clip extending from a back of the first side member, and a fourth curved clip extending from a back of the second side member.

18. The TV cover of claim 17, wherein a first gap is comprised between the first curved clip and the second curved clip, a second gap is comprised between the second curved clip and the third curved clip, a third gap is comprised between the third curved clip and the fourth curved clip, and a fourth gap is comprised between the fourth curved clip and the first curved clip.

19. The TV cover of claim 15, wherein the rigid rectangle and the plurality of curved clips are formed of a rigid polymer.

20. The TV cover of claim 15, wherein the rigid rectangle and the plurality of curved clips are formed of a single piece of polymer.
